(19) United States
(12) Patent Application Publication
(10) Pub. No.: US 2020/0314126 A1
(43) Pub. Date: Oct. 1, 2020

(54) PERSONA-BASED CONTEXTUAL SECURITY

(71) Applicant: McAfee, LLC, Santa Clara, CA (US)

(72) Inventors: Craig Schmugar, Beaverton, OR (US); Robert Leong, Beaverton, OR (US)

(73) Assignee: McAfee, LLC, Santa Clara, CA (US)

(21) Appl. No.: 16/366,086

(22) Filed: Mar. 27, 2019

(51) Int. Cl. H04L 29/06

(52) U.S. Cl. CPC H04L 63/1425; H04L 63/102; H04L 63/20

(57) ABSTRACT

There is disclosed in one example a computing apparatus, including: a hardware platform including a processor and a memory; a contextual reputation store; and instructions encoded within the memory to provision a security agent configured to: create a user persona in the contextual reputation store based at least in part on the user's interaction with the computing apparatus; compute a persona-weighted reputation for an action and store the persona-weighted reputation action to the contextual reputation store; intercept a user action on the computing apparatus; determine a current user persona; determine from the contextual reputation store a persona-weighted reputation for the user action; and take a security action based at least in part on the persona-weighted reputation for the user action.

### FIELD OF THE SPECIFICATION

This disclosure relates in general to the field of network and device security, and more particularly, though not exclusively, to a system and method for providing persona-based contextual security.

### BACKGROUND

Modern computers often have always-on Internet connections. Such connections can provide multiple vectors for security threats to attack a system.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of a home network.

FIG. 2 illustrates various personas that a user may assume while operating a device.

FIG. 3 is a block diagram of a security infrastructure.

FIG. 4 illustrates the use of ring architecture to provide a hierarchy of privileged access to system resources.

FIG. 5 is a flowchart of a method that may be followed by a security agent.

FIG. 6 is a block diagram of a hardware platform.

FIG. 7 is a block diagram of components of a computing platform.

FIG. 8 is a block diagram of a central processing unit (CPU).

### SUMMARY

In an example, there is disclosed a computing apparatus, comprising: a hardware platform comprising a processor and a memory; a contextual reputation store; and instructions encoded within the memory to provision a security agent configured to: create a user persona in the contextual reputation store based at least in part on the user's interaction with the computing apparatus; compute a persona-weighted reputation for an action and store the persona-weighted reputation action to the contextual reputation store; intercept a user action on the computing apparatus; determine a current user persona; determine from the contextual reputation store a persona-weighted reputation for the user action; and take a security action based at least in part on the persona-weighted reputation for the user action.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Classical computer security relies on the concept of authentication. Authentication is a concept of determining from one or more factors that a user operating the machine is who he or she claims to be. For example, if Mary is an authorized user of the computing device, then authentication relies on the concept of verifying that a user interacting with the device who claims to be Mary is, in fact, Mary. This may be accomplished via a number of factors and mechanisms. One of the oldest security mechanisms is the username and password combination, wherein a human operator purporting to be Mary enters a username (e.g., “mary”) and a password that is purportedly known only by Mary. If the user operating the computer enters the correct combination of username and password, then the device concludes that the user is, in fact, Mary. Many authentication schemes build on this basic mechanism, such as by providing token-based or multifactor authentication. The most effective authentication schemes rely on at least two authentication factors selected from the three categories of something you know (e.g., a passphrase), something you have (e.g., a token, badge, or smart phone), and/or something you are (e.g., biometric authentication).

While strong authentication schemes provide effective security in many contexts, attackers and other bad actors often exploit this trust by convincing the user to take an action, or by injecting malicious code that allows the attacker to execute privileged processes with the privileges of the trusted user. In other words, an adversary may compromise a computer system to carry out a malicious attack. Unfortunately, these attacks often go unnoticed by the victim of the attack, who continues to operate the computer without realizing that it has been compromised. This can be particularly dangerous in contemporary computing systems, where individual users are required to manage their own devices. In this case, the individual user may need to have, or have access to, elevated system privileges to carry out administrative tasks.

The harm can be further compounded if the user is part of an enterprise. In those cases, the malicious software may cause harm not only to the individual user, but also to the enterprise as a whole and the individual users across the enterprise. It can be a challenge for enterprises to identify situations where a computer system or operator is behaving maliciously. Identifying malicious behavior is not necessarily a straightforward problem to solve.

One factor compounding the difficulty with identifying malicious activity is that a user may manifest different patterns of behavior or different “personalities” or “personas” on a single device. Furthermore, different users may sometimes share a single device—even sometimes sharing a login and password, despite the fact that this is not a best security practice. Remote administration can also introduce challenges, wherein a remote administrator can log into the user's device from an administration console and perform administrative tasks.

The challenges can be further compounded by contemporary trends in computing. For example, many enterprises have implemented a bring your own device (BYOD) policy, which saves on enterprise information technology (IT) costs, by allowing the user to bear the cost of selecting and providing a device. Many users also prefer a BYOD policy, because it provides them greater flexibility in selecting a device that they prefer, and enables them to have a mixed-use device, such as having both personal and enterprise data and applications on a single device, rather than maintaining and keeping track of two or more separate devices. In a BYOD context, the enterprise may provide certain security functionality, such as an enterprise security application and protocol, and/or a virtual private network (VPN) that allows the user to access enterprise resources, while placing certain restrictions on that access to maintain enterprise security.

Other factors that may affect device security are shared devices, systems and users that fill different functions and roles, and authorized or unauthorized personal usage of company assets.

Without detailed knowledge of how applications are being utilized, administrators may be forced to sort users and systems into specific roles with defined security policies. However, the permissions for these security policies are often too sensitive or not sensitive enough, depending on the context. This can lead to frustration for the user, and can also increase enterprise IT costs, as users will require more support to operate their devices. Furthermore, applying mismatched policies opens the door for attackers to execute living off the land or other nontraditional attacks that are not based on installed malware.

To mitigate the impact of users operating in different roles, the present specification defines a system and method for providing persona-based contextual security.

One principle of persona-based contextual security is the identification of sensitive tasks being performed on a system at the same time as other human-executed tasks. This extends the notion of static user roles (e.g., administrator, power user, etc.) to dynamic contextual roles. For example, a user may have administrative privileges, but if the user is currently acting in a persona wherein that user is not expected to use those administrative privileges, then the performance of administrative actions during that context may be deemed suspicious. In other words, embodiments of the present specification may include a security agent that recognizes a conflict between user personas and user actions, even if those actions are permitted broadly by the user's credentials.

The teachings of the present specification are predicated in part on the fact that humans have a limited capacity to perform more than one task at a time. “Multitasking” is a misnomer. In reality, an operator switches back and forth between discrete tasks, performing them one at a time, rather than performing them simultaneously. While it is true that a user may initiate a computer process that then goes on and performs other tasks, the context of those actions may also be informative. For example, a user who is currently playing a game is not generally expected to also be launching system administrative scripts. This may be true even though the user is broadly authorized to perform system administration, and may be expected to launch system administration scripts while acting as a system administrator.

The teachings of the present specification provide for the dynamic enablement and disablement of features based on local, organizational, and global context. In these contexts, persona enforcement protection may be applied. For example, if the user wants to act in an administrator role, the user may first be required to switch from a “gamer” context, or at least manually move mouse and/or keyboard focus from a game application to an administrator application. This is superior to existing solutions that treat users and/or systems as a single entity and that do not accommodate the notion of multiple personas per user or system. These existing systems may in some cases suffer from extensive usability problems, because they often falsely identify normal behavior as abnormal, or falsely identify abnormal behavior as normal.

Embodiments of the present specification are illustrated with reference to a fictional example user Mary. Throughout the remainder of the specification, where an example or illustration refers to user Mary, or to Mary's specific circumstances, it should be understood that Mary is used to broadly stand for a class of users that may benefit from the teachings of the specification. Thus, the teachings described herein should not be understood to be limited to the specific situations, context, or examples illustrated. Rather, these illustrations are provided to aid understanding of the teachings of the specification, and can be easily abstracted to apply to other circumstances.

In the illustrative example, Mary is a senior software engineer at a major technology firm. Mary's enterprise has a BYOD policy, which allows Mary to purchase her own high-end laptop that she can use for both business and personal operations. Because Mary uses her personal laptop for both enterprise and personal purposes, Mary also has to act as a system administrator for the device, installing software, uninstalling software, and otherwise managing the device. To facilitate enterprise security, Mary's laptop conforms to an enterprise security protocol, including the installation of certain enterprise security software, and a VPN that controls her access to enterprise resources from her personal device.

As Mary is a professional programmer, she has a high-end laptop with a highly capable processor, high-end graphics card, large hard disk, and large memory capacity. Mary spends the majority of her time during working hours working on programming tasks. But Mary also has personal and recreational hobbies. In this case, Mary is also a gamer who enjoys complex strategy games such as “Civilization,” and also casual adult games such as “The Sims.” At certain times, even during the workday, she may take breaks (such as a lunch break), and during her break may spend time gaming. Mary is approaching her 10th anniversary with her husband Roger, who is a financial analyst. Mary and Roger are planning to celebrate their ten-year anniversary by taking a trip to southern Italy. Thus, Mary also sometimes uses her device to make travel arrangements, research travel topics, and prepare for her trip to Italy. Mary and Roger have an eight-year-old son Scott, who has attention deficit disorder (hyperactive subtype), commonly known as ADHD. Because Mary is concerned about her son's mental health, she also works for a nonprofit fundraising and advocacy organization that raises awareness of ADHD, and advocates for better treatment options for children with ADHD. Mary uses her laptop to participate in these volunteer activities. And because of her natural leadership skills, Mary was put in charge of a fundraising gala for the nonprofit organization. This means that Mary also uses her device for event organizing. Furthermore, although Mary is not generally a big clothes shopper, she needs to find appropriate semiformal attire for the upcoming gala, and thus, sometimes uses her computer to look at fashion sites and to shop for clothing.

Because Mary is a human and does not always perfectly follow security protocol, both Roger and Scott know her password, and sometimes log onto her computer for various reasons. For example, Scott is a gamer, like his mother, and prefers using Mary's laptop to the older desktop computer in the den, because Mary's laptop has a higher-end graphics card. Scott likes playing “Minecraft” and “Fortnite.” Roger prefers the desktop machine in the den with the bigger monitor, but sometimes borrows Mary's device when it is handy to check stocks and place buy or sell orders.

The foregoing scenario permits a security agent to define a number of discrete personas for Mary. These personas are based on Mary's regular and recurring activities. For example, the security agent may define a persona for “employee/programmer Mary,” a persona for “gamer Mary,” and a persona for “volunteer Mary.” The names assigned to these personas (employee/programmer, gamer, volunteer) are used for the convenience of the reader and to illustrate the purpose of each persona. The security agent need not necessarily assign names or characters to personas, but rather simply defines a list of different personas based on different usage patterns.

There are also usage patterns that do not fit well with any of the well-defined Mary personas. For example, Mary's current interest in travel and intense focus on southern Italy may be transitory events that will pass after Mary and Roger take their trip. Mary's interest in shopping for semiformal clothing may also pass once the fundraising gala has occurred. Roger's occasional use of Mary's laptop to check and trade stocks may occur regularly but infrequently. Scott's use of Mary's laptop to play his preferred games may occur somewhat frequently, but less frequently than Mary's use of the laptop to play her preferred games. Furthermore, although Scott and Mary both play games on the computer, the games they play are very different from one another, and they may interact with the device in different ways.

Once the security agent has identified a number of personas for Mary, a second aspect of the specification is to detect “Mary” (or a user assumed to be Mary) entering and exiting the various personas, and to determine when actions taken with a persona are in conflict with the actions expected of that persona. This may be relevant particularly when the persona conflict represents a potential security breach (e.g., an administrative action, such as changing permissions or creating a user account), or a potential privacy breach (e.g., sending personally-identifying information or financial information).

In provisioning and profiling personas, the security agent running on the local system may analyze user activity to build dynamic models of behavior based on the application, system, network interactions, and other factors to segregate related interactions into separate “persona models” that accurately baseline and predict what would be considered “normal behavior” within each persona model. By creating persona models, the security agent can understand when a user is acting like an administrator, power user, administrative assistant, gamer, researcher, volunteer, or engaging in other behavior. This enables the security agent to establish with greater accuracy what is considered “baseline behavior” within each context, versus what is abnormal within that context. This enables the detection of “odd” or otherwise uncharacteristic behaviors relative to the specific role or context that the user is acting in at the moment. This enables a security agent to apply correct policies to the behavior in context of the user's current persona.

A system and method for providing persona-based contextual security will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

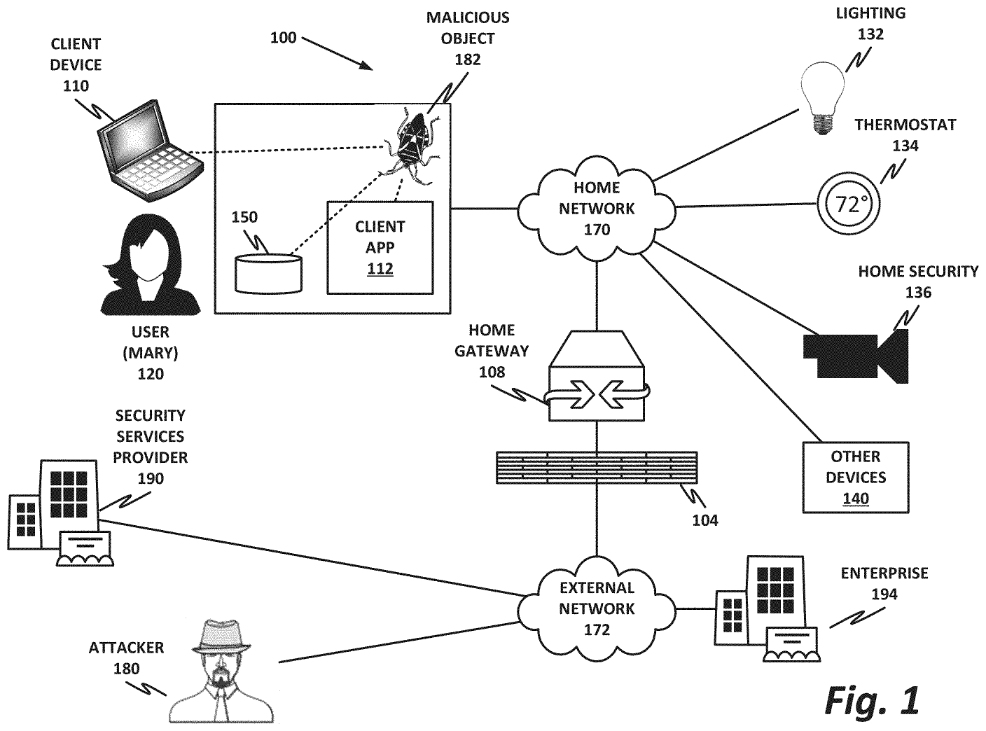

FIG. 1 is a block diagram of a home network 100. Embodiments of home network 100 may be configured or adapted to provide the method of providing persona-based contextual security as disclosed in the present specification.

In the example of FIG. 1, home network 100 may be a “smart home” with various Internet of things (IoT) devices that provide home automation or other services. Home network 100 is provided herein as an illustrative and nonlimiting example of a system that may employ and benefit from the teachings of the present specification. But it should be noted that the teachings may also be applicable to many other entities including, by way of nonlimiting example, an enterprise, data center, telecommunications provider, government entity, or other organization.

Within home network 100, one or more users 120 operate one or more client devices 110. A single user 120 (who may be user “Mary” in the examples presented herein) and single client device 110 (which may be, for example, Mary's high-end laptop) are illustrated here for simplicity, but a home or enterprise may have multiple users, each of which may have multiple devices.

Client devices 110 may be communicatively coupled to one another and to other network resources via home network 170. Client applications 112 may include a VPN that enables Mary to access enterprise resources either when she is on-site with enterprise 194, or via external network 172 from home network 170. Home network 170 may be any suitable network or combination of one or more networks operating on one or more suitable networking protocols, including a local area network, an intranet, a virtual network, a wide area network, a wireless network, a cellular network, or the Internet (optionally accessed via a proxy, virtual machine, or other similar security mechanism) by way of nonlimiting example. Home network 170 may also include one or more servers, firewalls, routers, switches, security appliances, antivirus servers, or other network devices, which may be single-purpose appliances, virtual machines, containers, or functions running on client devices 110.

In this illustration, home network 170 is shown as a single network for simplicity, but in some embodiments, home network 170 may include any number of networks, such as one or more intranets connected to the Internet. Home network 170 may also provide access to an external network, such as the Internet, via external network 172. External network 172 may similarly be any suitable type of network.

Home network 170 may connect to the Internet via a home gateway 108, which may be responsible, among other things, for providing a logical boundary between home network 172 and external network 170. Home network 170 may also provide services such as dynamic host configuration protocol (DHCP), gateway services, router services, and switching services, and may act as a security portal across home boundary 104.

Home network 100 may also include a number of discrete IoT devices, which in contemporary practice are increasing regularly. For example, home network 100 may include IoT functionality to control lighting 132, thermostats or other environmental controls 134, a home security system 136, and any number of other devices 140. Other devices 140 may include, as illustrative and nonlimiting examples, network attached storage (NAS), computers, printers, smart televisions, smart refrigerators, smart vacuum cleaners and other appliances, and network connected vehicles.

Home network 100 may communicate across home boundary 104 with external network 172. Home boundary 104 may represent a physical, logical, or other boundary. External network 172 may include, for example, websites, servers, network protocols, and other network-based services. In one example, an attacker 180 (or other similar malicious or negligent actor) also connects to external network 172. A security services provider 190 may provide services to home network 100, such as security software, security updates, network appliances, or similar. For example, MCAFEE, LLC provides a comprehensive suite of security services that may be used to protect home network 100.

It may be a goal of users 120 and home network 100 to successfully operate client devices 110 and IoT devices without interference from attacker 180 or from unwanted security objects. In one example, attacker 180 is a malware author whose goal or purpose is to cause malicious harm or mischief, for example, by injecting malicious object 182 into client device 110. According to embodiments of the present specification, malicious object 182 may include a fileless attack or a living off the land attack. Fileless attacks or living off the land attacks may be considered security threats or attacks, by way of nonlimiting example. Once malicious object 182 gains access to client device 110, it may try to perform work such as social engineering of user 120, a hardware-based attack on client device 110, modifying storage 150 (or volatile memory), modifying client application 112 (which may be running in memory), or gaining access to home resources. Furthermore, attacks may also be directed at IoT objects. IoT objects can introduce new security challenges, as they may be highly heterogeneous, and in some cases may be designed with minimal or no security considerations. To the extent that these devices have security, it may be added on as an afterthought. Thus, IoT devices may in some cases represent new attack vectors for attacker 180 to leverage against home network 170.

Malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110 or any of the IoT devices described. As used throughout this specification, malicious software (“malware”) includes any security object configured to provide unwanted results or do unwanted work. In many cases, malware objects will be executable objects, including, by way of nonlimiting examples, viruses, Trojans, zombies, rootkits, backdoors, worms, spyware, adware, ransomware, dialers, payloads, malicious browser helper objects, tracking cookies, loggers, or similar objects designed to take a potentially-unwanted action, including, by way of nonlimiting example, data destruction, covert data collection, browser hijacking, network proxy or redirection, covert tracking, data logging, keylogging, excessive or deliberate barriers to removal, contact harvesting, and unauthorized self-propagation.

In enterprise cases, attacker 180 may also want to commit industrial or other espionage, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In embodiments of the present specification, attacker 180 may attempt to inject a malicious object 182 into client device 110 that piggybacks on Mary's authentication to client device 110. For example, malicious object 182 may try to create a remote login back door for attacker 180 while Mary is performing other tasks. Mary may be unaware that attacker 180 has compromised her device and installed the back door.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device. Buffer overruns may be the result, for example, of poor input validation or use of insecure libraries, and in many cases arise in nonobvious contexts. Thus, although not malicious, a developer contributing software to an application repository or programming an IoT device may inadvertently provide attack vectors for attacker 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Home network 100 may contract with or subscribe to a security services provider 190, which may provide security services, updates, antivirus definitions, patches, products, and services. MCAFEE, LLC is a nonlimiting example of such a security services provider that offers comprehensive security and antivirus solutions. In some cases, security services provider 190 may include a threat intelligence capability such as the global threat intelligence (GTI) database provided by MCAFEE, LLC. Security services provider 190 may update its threat intelligence database by analyzing new candidate malicious objects as they appear on client networks and characterizing them as malicious or benign.

Other considerations may include parents' desire to protect their children from undesirable content, such as pornography, adware, spyware, age-inappropriate content, advocacy for certain political, religious, or social movements, or forums for discussing illegal or dangerous activities, by way of nonlimiting example.

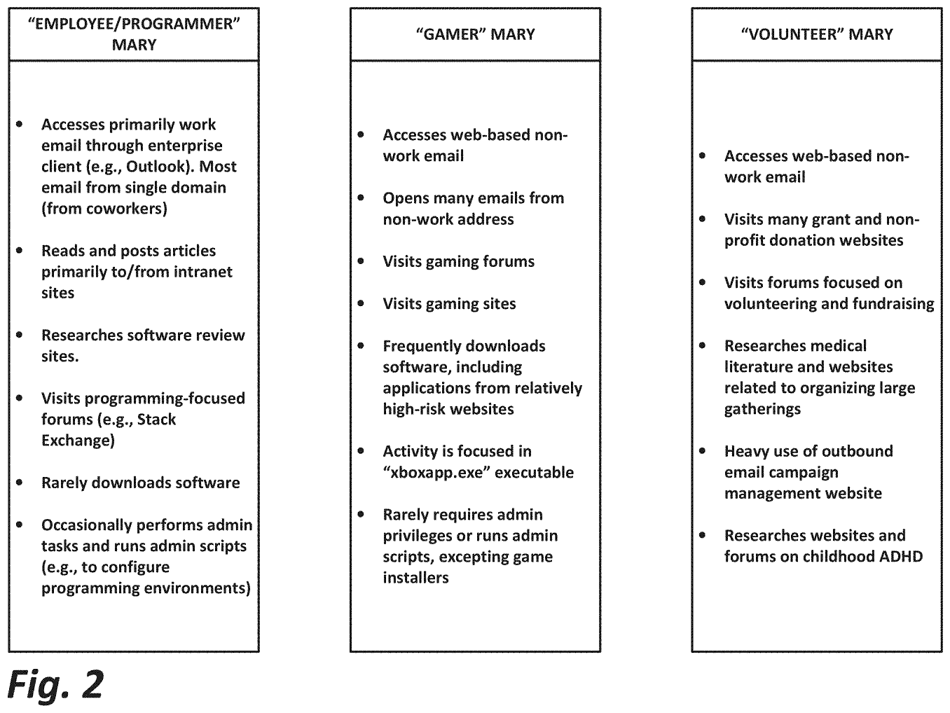

FIG. 2 illustrates various personas that Mary may assume while operating her device. A security agent on the device may profile Mary's activity and build dynamic models of behavior based on factors such as the application, system, and network interactions to segregate related interactions into Mary's various personas. To correctly build an accurate set of persona models, the security agent may start with the assumption that for an individual device, such as Mary's laptop, there may be one person with multiple personas, or multiple people using the single device, either with the same or different logins.

Starting with this assumption, the security agent may create one or more persona models based on statistically-correlated collections of baseline interactions. This may be accomplished, for example, via supervised learning, which involves input into the invention of human-guided, explicit analysis. For example, when initially configuring the security agent, Mary may specifically inform the security agent that she should have a programmer persona, a gamer persona, and a volunteer persona. Mary may also provide information about the various personas. For example, Mary's programmer persona frequently uses one or more integrated development environments (IDEs), her gamer persona frequently uses the application xboxapp.exe, and her volunteer persona primarily uses e-mail and a web browser. Mary could further refine these personas by providing the security agent with a list of websites she visits in each persona, other applications she uses in each persona, and even activities that she does not expect to do in each persona. Note that this human training of personas is not necessary in every embodiment, but may aid in the creation of the personas. When human-aided, personas may have human-readable persona names. But the security agent is usually not restricted in creating other personas besides those identified by the user, or in modifying the personas beyond the inputs provided by the human user. In some cases, a graphical user interface (GUI) or other interface may be provided so that the user can view and tweak both the human-created personas, as well as personas created by the security agent, autonomously. Again, while this step is not strictly necessary, it does give the user the ability to provide input and feedback, and to refine the process.

In some cases, a security agent may also provide unsupervised learning, meaning that the security agent is allowed to automatically establish its own classifications and baselines, determined by its own algorithms without human guidance. Whether guided by human interaction or autonomously, the persona models (PMs) may be validated based on efficacy and usability, for example by comparing what is known (e.g., to humans) to be normal, versus abnormal interactions over time.

To identify the various personas, the order and sequence of events on a system may be captured over time, and machine learning may be applied. Initially, the personas may be based on a brief period of machine learning, which establishes one or more personas, along with baseline behaviors for those personas. Multiple features may be considered in the personas, including, by way of nonlimiting example: day of week, time of day, username, authentication method, authentication strength, machine name, parent application, child application, command parameters, resource source and destination, foreground application (window name, dimensions, runtime, foreground duration), user input method (mouse, keyboard, microphone, etcetera), and others.

In one embodiment, strength of authentication or number of authentication factors may be useful not only in detecting different personas, but also in a “soft” detection of whether the user is actually a different person. For example, Mary may have a username and passphrase combination, and may also be issued an RFID security token by her employer. When Mary authenticates with both the passphrase and the security token, it may be considered a strong authentication event, and Mary may be permitted additional privileges, such as privileges to access the VPN, and through the VPN, to access enterprise resources. It may be possible for Mary to authenticate to the device using only her username and passphrase combination. However, in those cases, her runtime privileges may be restricted. Thus, although Roger and Scott both know Mary's passphrase, and occasionally log onto her device to use it for personal purposes, neither one has Mary's RFID badge, and thus cannot access enterprise resources via the VPN. Thus, a strict division of personas can be built based on strength of authentication.

Other factors that may be used to identify personas include the order and sequence of events on a system. One or more events may be used to describe a persona. For example, consider the following sequence. In this case, acting as a local administrator, Mary performs the following actions:
1. [Monday@ 9:00:00 am] Start button pressed
2. [Monday@ 9:00:10 am] explorer.exe launches wmic.exe
3. [Monday@ 9:00:20 am] Keystrokes “useraccount” entered
4. [Monday@ 9:02:45 am] Outlook.exe becomes foreground application
5. [Monday @ 9:03:30 am] wmic.exe becomes foreground application
6. [Monday @ 9:03:50 am] Keystrokes “useraccount create name=Roger AccountType=Administrator” entered
7. [Monday @ 9:04:30 am] wmic.exe process terminated

Several things may be inferred from this sequence. First, the user Mary is likely performing local actions because the keyboard is used to enter keystrokes. Using those keystrokes, Mary launched a system administrator tool, Windows Management Instrumentation Command (WMIC). Mary switches between interacting with a productivity tool (Outlook) and the admin tool. This switching between different windows and tools is extremely common in contemporary computer operating systems that provide multitasking. Based on the timing, it can be observed that

Mary has carried out the tasks over the course of several minutes, which is consistent with human behavior rather than machine-driven scripting. Furthermore, it is seen that Mary is performing these actions at the start of the day, which may be consistent with her persona of performing such administrative tasks at the beginning of the day.

The culmination of these tasks may be that Mary has checked her e-mail, and has also created a separate login for Roger so that when he borrows her computer, he's using his own account instead of hers. Based on this sequence of events, it can be inferred that Mary is acting as an administrator. This administrator persona and details may then be compared with a pattern of behavior that occurs from Mary across the organization, as well as a pattern of behavior on the local system.

Later in the same day, the system may observe the following actions:
1. [Monday@ 12:00:00 pm] Start button pressed
2. [Monday@ 12:00:20 pm] explorer.exe launches xboxapp.exe
3. [Monday@ 12:00:30 pm] xboxapp.exe becomes foreground application
4. [Monday@ 12:01:00 pm] xboxapp.exe launch civ.exe
5. [Monday@ 12:01:10 pm] civ.exe becomes foreground application
6. [Monday@ 12:03:05 pm] cmd.exe launches wmic.exe useraccount create name=Attacker AccountType=Administrator
7. [Monday@ 12:03:06 pm] wmic.exe process terminates
8. [Monday@ 12:03:06 pm] cmd.exe process terminates

Here, it is observed that Mary is acting as a gamer. This may be, for example, Mary enjoying the game during her lunch break. But during this period of gamer activity, an administrator account was created rapidly, and the focus never shifted away from her civ.exe application. This is very different from the behavior that occurred in the morning, even though the net result was the same: namely, the creation of a new administrator user.

The knowledge of these scenarios allows for various security postures. For example, a gamer security policy may be associated with the gamer persona when it is active. In this case, the admin activities may be prompted, alerted or warned, and/or denied. The security agent can enforce discrete persona policies. For example, Mary may be asked or required to close out of the gamer persona before being allowed to assume the admin persona. In other words, Mary may need to exit, or at least shift focus away from, civ.exe before attempting to run the WMIC administrative console.

After observing Mary's behavior over an extended period of time, the security agent may build several discrete personas for Mary. These include “employee/programmer” Mary, “gamer” Mary, and “volunteer” Mary.

In the employee persona, Mary primarily accesses her work e-mail through an enterprise client such as Microsoft Outlook. Much or most of her e-mail comes from a single domain, namely her home domain, in the form of e-mails from various coworkers. While acting as an employee programmer, Mary reads and posts articles primarily to and from local intranet sites, such as employee message boards. She may research software review sites, and visit programming-focused forums such as Stack Exchange. In this persona, because Mary has the software that she needs to perform her job, which may be provided and controlled by her employer, Mary rarely needs to download new software. However, she does occasionally perform administrative tasks and run admin scripts, for example, to configure different programming environments, or to change optimizations for her machine.

During her downtime, Mary may operate under a gamer persona. Gamer Mary primarily accesses web-based, non-work e-mail, for example via a web-based Gmail client. In this persona, Mary receives and opens e-mails primarily from non-work addresses. She visits gaming forms and gaming websites to look for tips and cheats for her games. And in this persona, Mary frequently downloads software, because she likes to try new and different games. This may often include applications from relatively high-risk websites that she would not normally visit in her employee programmer persona. In this persona, most of Mary's local activity takes place within a gaming app, such as steam.exe, or xboxapp.exe, which may serve as a front end to then launch other individual games. While Mary's behavior in this persona may be considered relatively high-risk compared to her activities in the employee programmer persona, in the gamer persona, Mary rarely requires admin privileges other than those to install new games, and rarely (if ever) runs admin scripts.

In the volunteer persona, Mary primarily accesses web-based, non-work e-mail, as she does in the gamer persona. This may be the same or a different e-mail address from the one that she uses for her gamer persona. For example, the ADHD advocacy nonprofit that Mary volunteers for may provide her its own .org-based e-mail address that she uses for these activities. In this persona, Mary visits many grant and nonprofit donation websites, and also visits forums focused on volunteering and fundraising. Mary may research the latest medical literature on ADHD, as well as websites related to organizing large gatherings. She may rely heavily on an outbound e-mail campaign management website. She may also participate heavily in forums on childhood ADHD.

Note that Mary's activity in shopping for semiformal clothing and preparing for her trip to southern Italy does not fit nicely into any of these personas. In her “shopper” persona, Mary may visit online retailers, as well as read fashion blogs to keep up with the latest trends in women's clothing. If Mary's interest in shopping is relatively short-lived, then once she procures clothing for the gala, there may be no need to create a separate profile for “shopper Mary.” Rather, Mary's activity in the shopper persona may be treated as exceptions to her general profile, and the activity may be allowed so long as she does not engage in behavior that is a risk to the system.

On the other hand, if Mary and Roger's trip to southern Italy is several months away, and Mary gets very excited and starts spending lots of time reading travel blogs, reading about Italy, booking various tours, and doing other travel-related things, then the security agent may eventually determine that a new persona should be created for Mary. This may occur whether or not Mary explicitly instructs the security agent to create a new “world traveler Mary” persona. Once Mary and Roger take their trip to southern Italy, Mary's interest in travel topics may wane, and she may stop frequently visiting travel-related websites. When that occurs, the security agent may determine after some period of time that the “world traveler Mary” persona is stale, and may remove the persona from its list of personas.

Also note that when Roger and Scott use Mary's laptop, their activity may not fit neatly into any of Mary's defined personas. For example, although Roger uses the Internet and visits a web-based, non-work e-mail similar to “volunteer” Mary, he may visit a different e-mail provider, and/or use a different e-mail address. Furthermore, while Mary visits many websites related to her ADHD advocacy volunteering, Roger visits primarily financial news and stock-based websites. As above, if Roger uses Mary's laptop frequently enough, the security agent may create a new persona for Roger's use (whether or not it realizes or “knows” that Roger is, in fact, a separate user from Mary). In this persona, Roger may engage in activity that has potential security and privacy implications. For example, by engaging in stock trades, he is transmitting bank account information, and possibly transmitting personally-identifying information. When this first occurs, if it appears to be out of bounds of Mary's ordinary personas, a warning may be raised, such as a dialog box asking, “Are you sure you want to do this?” or something similar. After enough affirmative responses to this query, a new persona may be created that indicates that in this context, it is acceptable for Mary (actually Roger) to engage in these stock-related transactions.

Similarly, when Scott borrows Mary's laptop to play games, the security agent may observe that Scott uses a different gaming application from the one that Mary commonly uses. For example, Scott may like to launch minecraft.exe rather than steam.exe. In this persona, Scott engages in relatively low-risk behavior (simply running a gaming app as a normal user), especially if Mary initially installed the game for him in her ordinary persona. Because Scott's use of the computer is relatively low-risk, there may be no need for special verification. If Scott (or a bad actor) attempts to perform a questionable action while using Mary's computer, the action may be blocked, or specific authorization may be required. As before, if Scott uses Mary's computer frequently enough, a separate persona may be created for Scott, which may include an indication that Scott usually authenticates with Mary's passphrase, but not with Mary's RFID security token. Thus, in the Scott persona, administrative-type activities may be blocked, and access to resources such as the VPN and enterprise resources may be blocked. In some cases, access to certain directories, such as those which include enterprise data, may also be blocked absent special permission or verification from Mary.

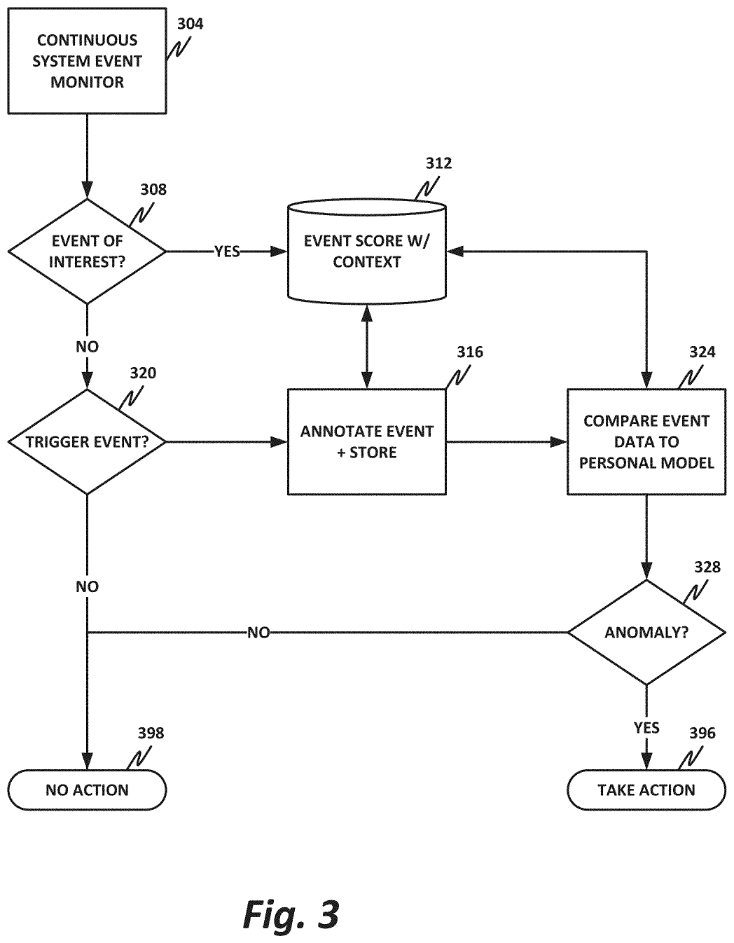

FIG. 3 is a block diagram of a security infrastructure. The security infrastructure of FIG. 3 may be used to facilitate the operation of a security agent as described herein.

Starting in block 304, the security agent utilizes a continuous system event monitor to watch for system events. This may include the use of operating system (OS) hooks and/or interrupts, or otherwise trapping system events so that the security functions can be performed. This continuous system monitoring may require elevated system privileges, and thus, the security agent may operate at a relatively high privilege level.

In decision block 308, the security agent determines whether the captured event is an event of interest. Events of interest may include, for example, a change in focus, the launching of a new application, the closing of an application, a user login, or any of the other events that may be used to influence a user's current persona.

If the event is not an event of interest that will bear on the user's persona, then in decision block 320, there is a check to see whether the event is a trigger event. A trigger event may be any event that occurs within a persona that may, for example, trigger a security response. This could be the user taking any action that might potentially be risky, that could compromise system security or privacy, or that could otherwise negatively impact the user or the system. Trigger events may include, for example, sending sensitive information via a network interface, system management such as creating a user or changing a configuration, or otherwise taking some sensitive action. If there is no event of interest in a trigger event, then in block 398, no action is taken.

Returning to block 308, if the event is an event of interest, then an event score is computed within context and stored within event score with context block 312. The event score may be a computation of a degree to which an event influences the user persona. For example, an event such as opening xboxapp.exe may determinatively indicate that the user has entered the gaming persona. The opening of an IDE application may determinatively indicate that the user is in the employee/programmer persona. Other events may have a less weighted influence on the persona change. For example, a change in focus may indicate that the user is working on a different task, but for practical purposes may still be in the same context.

The computation, with respect to the event, includes both a feedforward function and a feedback function. In other words, in the feedforward context, the event can be used to determine whether the user's persona should be switched to a different persona. In the feedback context, the event may be used to strengthen or modify the user's persona so that better decisions can be made based on the persona in the future.

Returning to decision block 320, if the event is a trigger event, then the security agent may be required to make a decision about the security of the event. In block 316, the security agent may annotate the event and store it in event score with context block 312. This gives the event a weighted reputation that is specifically applicable to the user's persona (e.g., a persona-weighted reputation). For example, when Mary is in the gamer persona, an action such as creating a new user may have a low reputation, while if Mary is in a system administrator persona, the same event of creating a new user may have a relatively high reputation. Note that in this example, a “high” reputation is used to indicate that an event is permissible or should be allowed, while a “low” reputation is used to indicate that an action is suspect or may need to be blocked. The use of high and low in this context is not intended to require that the particular computation be a specific integer with a larger or smaller magnitude, but is simply used to conceptually present the idea that a high reputation event is more likely to be permissible within the persona than a low reputation event. In block 324, the security agent compares the event data to the persona model, to compute the reputation of the event in context of the persona.

In some cases, the persona includes a profile with specific numerical weights for certain actions, and those numerical weights can be used as a multiplier for a baseline reputation for an action. For example, a probability range may be defined, with 0 being absolutely prohibited (0% probability that the action is allowed), and 1 being absolutely allowed (100% probability that the action allowed). The action of creating a new administrator account may have a baseline reputation of 0.3, which is this illustrative example is low enough that it requires user verification before it is allowed. In the Programmer/Employee persona, a modifier of 1.35 may be applied, thus increasing the reputation of the action over 0.4, which in this example puts the action over a threshold, so that special user permission is no longer required. In the Gamer persona, a modifier of 0.5 is applied to the action, which reduces the reputation to 0.15, which may require both permission and an administrator password. In the Volunteer persona, a modifier of 0.4 is applied, reducing the reputation to 0.12, which also requires both permission and a password.

In decision block 328, the security agent determines whether there is an anomaly in the event. For example, if the event appears to be out of context, or happens very rapidly without any apparent parent script, then an anomaly may be detected. If there is an anomaly, then the security agent may take appropriate action in block 396. The appropriate action could include blocking the event, notifying a user, notifying a security administrator, uploading data to a security service, or taking any other remedial action that may help to mitigate damage from the anomalous event. If there is no anomaly, then in block 398, the method is done.

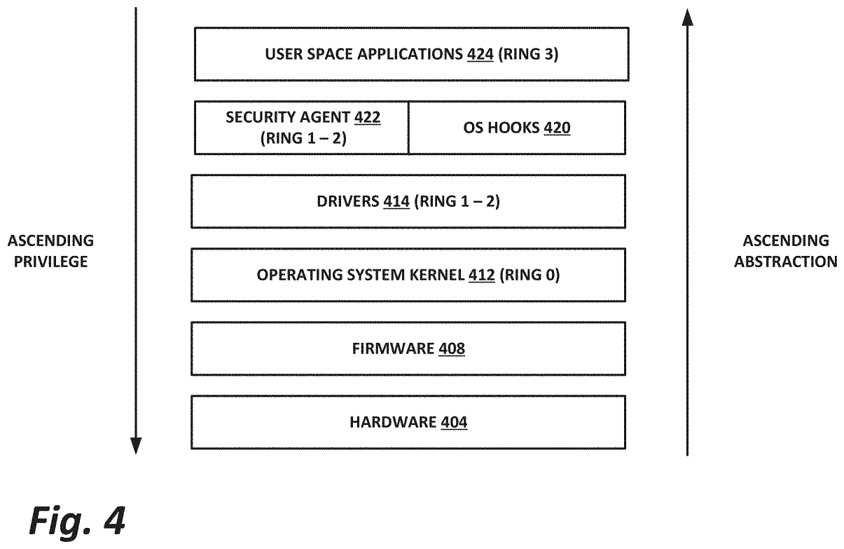

FIG. 4 illustrates the use of ring architecture to provide a hierarchy of privileged access to system resources.

In some embodiments, an operating system may provide different levels of access to resources based on which “ring” (e.g., privilege level) a process is associated with. The rings of FIG. 4 should be understood to be a logical representation of data flow and structures, and not necessarily a physical division or structure. A “lower level” ring may be a ring that has more direct access to hardware and resources, and that may provide interfaces for “higher level” rings to access the hardware and resources in controlled ways. It should be understood that software does not physically reside within a ring, but rather that particular processes may be associated with specific protection rings in a hierarchical fashion.

In general, processes assigned to lower level rings (such as those in firmware block 408, operating system kernel 412, and drivers 414) require a greater degree of privilege and/or direct access to hardware. Processes assigned to higher level rings (e.g., user-space applications 424) may be accessed by users with lesser privilege, and may access certain resources only via well-defined application programming interfaces (APIs) provided in the lower ring. In conjunction with the system event monitor of FIG. 3, security agent 422 may “hook” certain low-level operating system calls via OS hooks 420 to intercept user actions. Security agent 422 may then assign a persona-based contextual security score or reputation to certain actions according to the teachings of the present specification.

In an embodiment, access to protection rings may be hardware-enforced by some CPU architectures that provide different CPU modes at the hardware or microcode level. Rings may be arranged in a hierarchy from most privileged/trusted (ring 0) to least privileged/trusted (highest ring number, in this case ring 3). Ring 0 may interact most directly with the physical hardware 404 such as the CPU and memory.

“Gates” may be provided, for example via an application programming interface (API) or framework, between rings to allow a process associated with an outer ring to access a resource with privileges owned or controlled by an inner ring. This can prevent processes having only the privileges of a higher ring from misusing resources whose privileges are owned by a lower ring. For example, a malicious object such as malicious object 182 of FIG. 1 (in this case, restricted to ring 3 privileges) may be prevented from directly accessing hardware resources (like a web camera, microphone, or key logger that could be turned on to spy on a user) if hardware access is limited to ring 1 or lower (thus allowing drivers to access hardware directly). Any attempt to bypass these limitations, especially within the context of a persona that is not expected to perform low-level hardware maintenance, may be blocked or flagged as suspicious.

By way of nonlimiting example, software such as a web browser associated with higher numbered rings may still access these resources, but only via defined requests that are directed to and managed by software associated with lower rings. This limits access to resources by higher-ring processes, thus preventing abuse from malicious object 182, and other potentially harmful processes.

A system may track the logical rings assigned to executing instruction threads via machine registers. Processor hardware within the system may restrict the manner in which control can be passed from one ring to another, and may also enforce restrictions on the types of memory access that can be performed across rings. Using the x86 architecture as an example, a gate structure is provided, referenced by call instructions that transfer control securely toward predefined entry points in a lower level logical ring. These function as “supervisor” calls in many operating systems that use a ring-type architecture. The hardware restrictions may limit opportunities for accidental or malicious breaches of security.

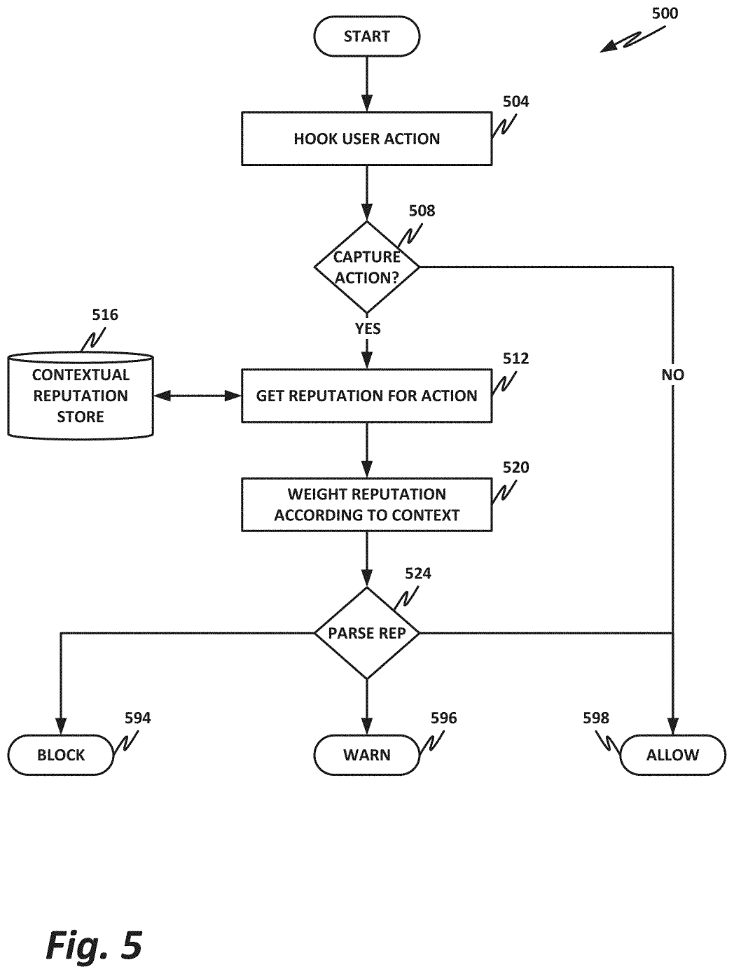

FIG. 5 is a flowchart of a method 500 that may be followed by a security agent. Starting in block 504, the security agent hooks or otherwise intercepts a user action, such as opening an application or taking an administrative action.

In decision block 508, the security agent determines whether this is an action that should be captured, or in other words, if this is an action that has potential security implications. If the action is not to be captured, then in block 598, the action is allowed, and the method is done.

Returning to block 508, if the action is to be captured, then in block 512, the security agent receives a reputation for the action from contextual reputation store 516. This is a reputation for the action in context of the user's current persona. Thus, a query to contextual reputation store 516 may require the security agent to determine the user's current persona. This may be accomplished, for example, because the persona was established when there was a persona switch. If there is no current persona, then a generic persona template may be applied that simply evaluates the reputation of the action as though the user has no persona.

In block 520, the reputation for the action is weighted according to the context. For example, if Mary is acting as a system administrator persona right now, then a system administration action may have a relatively high reputation. However, if Mary is currently acting in the gamer persona, then a system administration action may have a relatively lower reputation. In some embodiments, an actual weighted fraction may be attached to the baseline reputation of the action with the weighted fraction being a product of the user's current persona.

In block 524, the security agent parses the current reputation. This is to determine whether the reputation meets certain thresholds. Depending on the threshold, the action may be selected appropriately. In one example, the action is selected from the group consisting of “allow” in block 598, “warn” in block 596, or “block” in block 594. Depending on the threshold of the value, the appropriate action is taken, and the method is done.

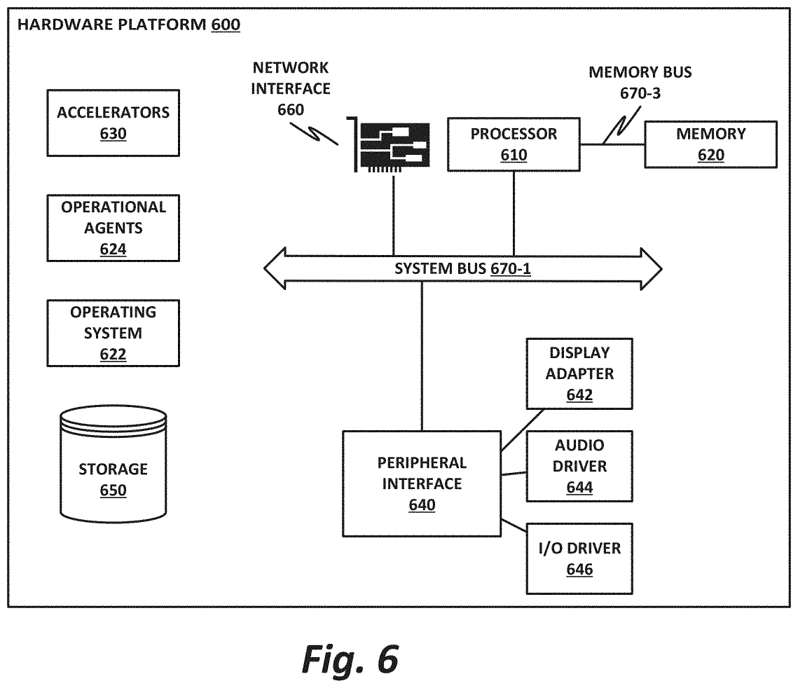

FIG. 6 is a block diagram of hardware platform 600. Embodiments of hardware platform 600 may be configured or adapted to provide the method of providing persona-based contextual security as disclosed in the present specification.

Hardware platform 600 may represent any suitable computing device. In various embodiments, a “computing device” may be or comprise, by way of nonlimiting example, a computer, workstation, server, mainframe, virtual machine (whether emulated or on a “bare-metal” hypervisor), network appliance, container, IoT device, embedded computer, embedded controller, embedded sensor, personal digital assistant, laptop computer, cellular telephone, Internet protocol (IP) telephone, smart phone, tablet computer, convertible tablet computer, computing appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it, including any device hosted on the same hardware but that is logically separated (e.g., a different virtual machine, container, or guest) may be designated as a “remote host.”

In certain embodiments, client devices 110, home gateway 108, and the IoT devices illustrated in FIG. 1 may all be examples of devices that run on a hardware platform such as hardware platform 600. FIG. 6 presents a view of many possible elements that may be included in a hardware platform, but it should be understood that not all of these are necessary in every platform, and platforms may also include other elements. For example, peripheral interface 640 may be an essential component in a user-class device to provide input and output, while it may be completely unnecessary in a virtualized server or hardware appliance that communicates strictly via networking protocols.

By way of illustrative example, hardware platform 600 provides a processor 610 connected to a memory 620 and other system resources via one or more buses, such a system bus 670-1 and a memory bus 670-3.

Other components of hardware platform 600 include a storage 650, network interface 660, and peripheral interface 640. This architecture is provided by way of example only, and is intended to be nonexclusive and nonlimiting. Furthermore, the various parts disclosed are intended to be logical divisions only, and need not necessarily represent physically separate hardware and/or software components. Certain computing devices provide main memory 620 and storage 650, for example, in a single physical memory device, and in other cases, memory 620 and/or storage 650 are functionally distributed across many physical devices. In the case of virtual machines or hypervisors, all or part of a function may be provided in the form of software or firmware running over a virtualization layer to provide the disclosed logical function, and resources such as memory, storage, and accelerators may be disaggregated (i.e., located in different physical locations across a data center). In other examples, a device such as a network interface 660 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

In various examples, a “processor” may include any combination of logic elements operable to execute instructions, whether loaded from memory, or implemented directly in hardware, including, by way of nonlimiting example, a microprocessor, digital signal processor, field-programmable gate array, graphics processing unit, programmable logic array, application-specific integrated circuit, or virtual machine processor. In certain architectures, a multi-core processor may be provided, in which case processor 610 may be treated as only one core of a multi-core processor, or may be treated as the entire multi-core processor, as appropriate. In some embodiments, one or more co-processors may also be provided for specialized or support functions.

Processor 610 may be communicatively coupled to devices via a system bus 670-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of nonlimiting example only, and that some embodiments may omit one or more of the foregoing buses, while others may employ additional or different buses. Common buses include peripheral component interconnect (PCI) and PCI express (PCIe), which are based on industry standards. However, system bus 670-1 is not so limited, and may include any other type of bus. Furthermore, as interconnects evolve, the distinction between a system bus and the network fabric is sometimes blurred. For example, if a node is disaggregated, access to some resources may be provided over the fabric, which may be or include, by way of nonlimiting example, Intel® Omni-Path™ Architecture (OPA), TrueScale™, Ultra Path Interconnect (UPI) (formerly called QPI or KTI), FibreChannel, Ethernet, FibreChannel over Ethernet (FCoE), InfiniBand, PCI, PCIe, or fiber optics, to name just a few.

In an example, processor 610 is communicatively coupled to memory 620 via memory bus 670-3, which may be, for example, a direct memory access (DMA) bus, though other memory architectures are possible, including ones in which memory 620 communicates with processor 610 via system bus 670-1 or some other bus. In the same or an alternate embodiment, memory bus 670-3 may include remote direct memory access (RDMA), wherein processor 610 accesses disaggregated memory resources via DMA or DMA-like interfaces.

To simplify this disclosure, memory 620 is disclosed as a single logical block, but in a physical embodiment may include one or more blocks of any suitable volatile or nonvolatile memory technology or technologies, including, for example, double data rate random-access memory (DDR RAM), static random-access memory (SRAM), dynamic random-access memory (DRAM), persistent random-access memory (PRAM), or other similar persistent fast memory, cache, Layer 1 (L1) or Layer 2 (L2) memory, on-chip memory, registers, flash, read-only memory (ROM), optical media, virtual memory regions, magnetic or tape memory, or similar. In certain embodiments, memory 620 may comprise a relatively low-latency volatile main memory, while storage 650 may comprise a relatively higher-latency nonvolatile memory. However, memory 620 and storage 650 need not be physically separate devices, and in some examples may represent simply a logical separation of function. It should also be noted that although DMA is disclosed by way of nonlimiting example, DMA is not the only protocol consistent with this specification, and that other memory architectures are available.

Storage 650 may be any species of memory 620, or may be a separate device. Storage 650 may include one or more non-transitory computer-readable mediums, including, by way of nonlimiting example, a hard drive, solid-state drive, external storage, microcode, hardware instructions, redundant array of independent disks (RAID), network attached storage, optical storage, tape drive, backup system, cloud storage, or any combination of the foregoing. Storage 650 may be, or may include therein, a database or databases or data stored in other configurations, and may include a stored copy of operational software such as operating system 622 and software portions, if any, of operational agents 624, accelerators 630, or other engines. Many other configurations are also possible, and are intended to be encompassed within the broad scope of this specification.

As necessary, hardware platform 600 may include an appropriate operating system, such as Microsoft Windows, Linux, Android, Mac OSX, Apple iOS, Unix, or similar. Some of the foregoing may be more often used on one type of device than another. For example, desktop computers or engineering workstations may be more likely to use one of Microsoft Windows, Linux, Unix, or Mac OSX. Laptop computers, which are usually a portable, off-the-shelf device with fewer customization options, may be more likely to run Microsoft Windows or Mac OSX. Mobile devices may be more likely to run Android or iOS. However, these examples are not intended to be limiting. Furthermore, hardware platform 600 may be configured for virtualization or containerization, in which case it may also provide a hypervisor, virtualization platform, virtual machine manager (VMM), orchestrator, containerization platform, or other infrastructure to provide flexibility in allocating resources.

Network interface 660 may be provided to communicatively couple hardware platform 600 to a wired or wireless network or fabric. A “network,” as used throughout this specification, may include any communicative platform operable to exchange data or information within or between computing devices, including, by way of nonlimiting example, a local network, a switching fabric, an ad-hoc local network, an Internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Operational agents 624 are one or more computing engines that may include one or more non-transitory computer-readable mediums having stored thereon executable instructions operable to instruct a processor to provide operational functions. At an appropriate time, such as upon booting hardware platform 600 or upon a command from operating system 622 or a user or security administrator, processor 610 may retrieve a copy of operational agents 624 (or software portions thereof) from storage 650 and load it into memory 620. Processor 610 may then iteratively execute the instructions of operational agents 624 to provide the desired methods or functions.

As used throughout this specification, an “engine” includes any combination of one or more logic elements, of similar or dissimilar species, operable for and configured to perform one or more methods provided by the engine. In some cases, the engine may include a special integrated circuit designed to carry out a method or a part thereof, a field-programmable gate array (FPGA) programmed to provide a function, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware and software, including configuration files, registry entries, application programming interfaces (APIs), and interactive or user-mode software by way of nonlimiting example.

Peripheral interface 640 may be configured to interface with any auxiliary device that connects to hardware platform 600 but that is not necessarily a part of the core architecture of hardware platform 600. A peripheral may be operable to provide extended functionality to hardware platform 600, and may or may not be wholly dependent on hardware platform 600. In some cases, a peripheral may be a computing device in its own right. Peripherals may include input and output devices such as displays, terminals, printers, keyboards, mice, modems, data ports (e.g., serial, parallel, universal serial bus (USB), Firewire, or similar), network controllers, optical media, external storage, sensors, transducers, actuators, controllers, data acquisition buses, cameras, microphones, speakers, or external storage, by way of nonlimiting example.

In one example, peripherals include display adapter 642, audio driver 644, and input/output (I/O) driver 646. Display adapter 642 may be configured to provide a human-readable visual output, such as a command-line interface (CLI) or graphical desktop such as Microsoft Windows, Apple OSX desktop, or a Unix/Linux X Window System-based desktop. Display adapter 642 may provide output in any suitable format, such as a coaxial output, composite video, component video, video graphics array (VGA), or digital outputs such as digital visual interface (DVI) or high definition multimedia interface (HDMI), by way of nonlimiting example. In some examples, display adapter 642 may include a hardware graphics card, which may have its own memory and its own graphics processing unit (GPU). Audio driver 644 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of nonlimiting example.

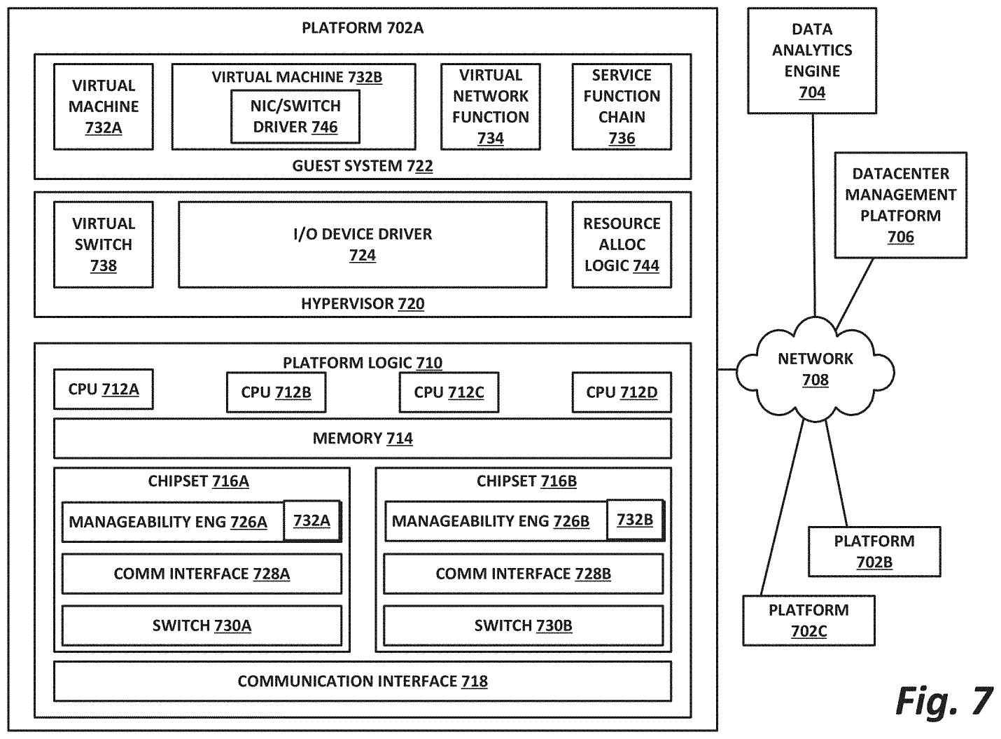

FIG. 7 is a block diagram of components of a computing platform 702A. Embodiments of computing platform 702A may be configured or adapted to provide the method of providing persona-based contextual security as disclosed in the present specification.

In the embodiment depicted, platforms 702A, 702B, and 702C, along with a data center management platform 706 and data analytics engine 704 are interconnected via network 708. In other embodiments, a computer system may include any suitable number (i.e., one or more) of platforms. In some embodiments (e.g., when a computer system only includes a single platform), all or a portion of the system management platform 706 may be included on a platform 702. A platform 702 may include platform logic 710 with one or more central processing units (CPUs) 712, memories 714 (which may include any number of different modules), chipsets 716, communication interfaces 718, and any other suitable hardware and/or software to execute a hypervisor 720 or other operating system capable of executing workloads associated with applications running on platform 702. In some embodiments, a platform 702 may function as a host platform for one or more guest systems 722 that invoke these applications. Platform 702A may represent any suitable computing environment, such as a high performance computing environment, a data center, a communications service provider infrastructure (e.g., one or more portions of an Evolved Packet Core), an in-memory computing environment, a computing system of a vehicle (e.g., an automobile or airplane), an Internet of things environment, an industrial control system, other computing environment, or combination thereof.

In various embodiments of the present disclosure, accumulated stress and/or rates of stress accumulated of a plurality of hardware resources (e.g., cores and uncores) are monitored and entities (e.g., system management platform 706, hypervisor 720, or other operating system) of computer platform 702A may assign hardware resources of platform logic 710 to perform workloads in accordance with the stress information. In some embodiments, self-diagnostic capabilities may be combined with the stress monitoring to more accurately determine the health of the hardware resources. Each platform 702 may include platform logic 710. Platform logic 710 comprises, among other logic enabling the functionality of platform 702, one or more CPUs 712, memory 714, one or more chipsets 716, and communication interfaces 728. Although three platforms are illustrated, computer platform 702A may be interconnected with any suitable number of platforms. In various embodiments, a platform 702 may reside on a circuit board that is installed in a chassis, rack, or other suitable structure that comprises multiple platforms coupled together through network 708 (which may comprise, e.g., a rack or backplane switch).

CPUs 712 may each comprise any suitable number of processor cores and supporting logic (e.g., uncores). The cores may be coupled to each other, to memory 714, to at least one chipset 716, and/or to a communication interface 718, through one or more controllers residing on CPU 712 and/or chipset 716. In particular embodiments, a CPU 712 is embodied within a socket that is permanently or removably coupled to platform 702A. Although four CPUs are shown, a platform 702 may include any suitable number of CPUs.

Memory 714 may comprise any form of volatile or nonvolatile memory including, without limitation, magnetic media (e.g., one or more tape drives), optical media, RAM, ROM, flash memory, removable media, or any other suitable local or remote memory component or components. Memory 714 may be used for short, medium, and/or long term storage by platform 702A. Memory 714 may store any suitable data or information utilized by platform logic 710, including software embedded in a computer-readable medium, and/or encoded logic incorporated in hardware or otherwise stored (e.g., firmware). Memory 714 may store data that is used by cores of CPUs 712. In some embodiments, memory 714 may also comprise storage for instructions that may be executed by the cores of CPUs 712 or other processing elements (e.g., logic resident on chipsets 716) to provide functionality associated with the manageability engine 726 or other components of platform logic 710. A platform 702 may also include one or more chipsets 716 comprising any suitable logic to support the operation of the CPUs 712. In various embodiments, chipset 716 may reside on the same die or package as a CPU 712 or on one or more different dies or packages. Each chipset may support any suitable number of CPUs 712. A chipset 716 may also include one or more controllers to couple other components of platform logic 710 (e.g., communication interface 718 or memory 714) to one or more CPUs. In the embodiment depicted, each chipset 716 also includes a manageability engine 726. Manageability engine 726 may include any suitable logic to support the operation of chipset 716. In a particular embodiment, a manageability engine 726 (which may also be referred to as an innovation engine) is capable of collecting real-time telemetry data from the chipset 716, the CPU(s) 712 and/or memory 714 managed by the chipset 716, other components of platform logic 710, and/or various connections between components of platform logic 710. In various embodiments, the telemetry data collected includes the stress information described herein.

In various embodiments, a manageability engine 726 operates as an out-of-band asynchronous compute agent which is capable of interfacing with the various elements of platform logic 710 to collect telemetry data with no or minimal disruption to running processes on CPUs 712. For example, manageability engine 726 may comprise a dedicated processing element (e.g., a processor, controller, or other logic) on chipset 716, which provides the functionality of manageability engine 726 (e.g., by executing software instructions), thus conserving processing cycles of CPUs 712 for operations associated with the workloads performed by the platform logic 710. Moreover, the dedicated logic for the manageability engine 726 may operate asynchronously with respect to the CPUs 712 and may gather at least some of the telemetry data without increasing the load on the CPUs.

A manageability engine 726 may process telemetry data it collects (specific examples of the processing of stress information will be provided herein). In various embodiments, manageability engine 726 reports the data it collects and/or the results of its processing to other elements in the computer system, such as one or more hypervisors 720 or other operating systems and/or system management software (which may run on any suitable logic such as system management platform 706). In particular embodiments, a critical event such as a core that has accumulated an excessive amount of stress may be reported prior to the normal interval for reporting telemetry data (e.g., a notification may be sent immediately upon detection).

Additionally, manageability engine 726 may include programmable code configurable to set which CPU(s) 712 a particular chipset 716 will manage and/or which telemetry data will be collected.

Chipsets 716 also each include a communication interface 728. Communication interface 728 may be used for the communication of signaling and/or data between chipset 716 and one or more I/O devices, one or more networks 708, and/or one or more devices coupled to network 708 (e.g., system management platform 706). For example, communication interface 728 may be used to send and receive network traffic such as data packets. In a particular embodiment, a communication interface 728 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 716 (e.g., manageability engine 726 or switch 730) and another device coupled to network 708. In various embodiments an NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interfaces 728 may allow communication of data (e.g., between the manageability engine 726 and the data center management platform 706) associated with management and monitoring functions performed by manageability engine 726. In various embodiments, manageability engine 726 may utilize elements (e.g., one or more NICs) of communication interfaces 728 to report the telemetry data (e.g., to system management platform 706) in order to reserve usage of NICs of communication interface 718 for operations associated with workloads performed by platform logic 710.

Switches 730 may couple to various ports (e.g., provided by NICs) of communication interface 728 and may switch data between these ports and various components of chipset 716 (e.g., one or more Peripheral Component Interconnect Express (PCIe) lanes coupled to CPUs 712). Switches 730 may be a physical or virtual (i.e., software) switch.

Platform logic 710 may include an additional communication interface 718. Similar to communication interfaces 728, communication interfaces 718 may be used for the communication of signaling and/or data between platform logic 710 and one or more networks 708 and one or more devices coupled to the network 708. For example, communication interface 718 may be used to send and receive network traffic such as data packets. In a particular embodiment, communication interfaces 718 comprise one or more physical NICs. These NICs may enable communication between any suitable element of platform logic 710 (e.g., CPUs 712 or memory 714) and another device coupled to network 708 (e.g., elements of other platforms or remote computing devices coupled to network 708 through one or more networks).

Platform logic 710 may receive and perform any suitable types of workloads. A workload may include any request to utilize one or more resources of platform logic 710, such as one or more cores or associated logic. For example, a workload may comprise a request to instantiate a software component, such as an I/O device driver 724 or guest system 722; a request to process a network packet received from a virtual machine 732 or device external to platform 702A (such as a network node coupled to network 708); a request to execute a process or thread associated with a guest system 722, an application running on platform 702A, a hypervisor 720 or other operating system running on platform 702A; or other suitable processing request.

A virtual machine 732 may emulate a computer system with its own dedicated hardware. A virtual machine 732 may run a guest operating system on top of the hypervisor 720. The components of platform logic 710 (e.g., CPUs 712, memory 714, chipset 716, and communication interface 718) may be virtualized such that it appears to the guest operating system that the virtual machine 732 has its own dedicated components.

A virtual machine 732 may include a virtualized NIC (vNIC), which is used by the virtual machine as its network interface. A vNIC may be assigned a media access control (MAC) address or other identifier, thus allowing multiple virtual machines 732 to be individually addressable in a network.

VNF 734 may comprise a software implementation of a functional building block with defined interfaces and behavior that can be deployed in a virtualized infrastructure. In particular embodiments, a VNF 734 may include one or more virtual machines 732 that collectively provide specific functionalities (e.g., WAN optimization, VPN termination, firewall operations, load-balancing operations, security functions, etc.). A VNF 734 running on platform logic 710 may provide the same functionality as traditional network components implemented through dedicated hardware.

For example, a VNF 734 may include components to perform any suitable NFV workloads, such as virtualized evolved packet core (vEPC) components, mobility management entities (MMEs), 3rd Generation Partnership Project (3GPP) control and data plane components, etc.

SFC 736 is a group of VNFs 734 organized as a chain to perform a series of operations, such as network packet processing operations. Service function chaining may provide the ability to define an ordered list of network services (e.g., firewalls and load balancers) that are stitched together in the network to create a service chain.

A hypervisor 720 (also known as a virtual machine monitor) may comprise logic to create and run guest systems 722. The hypervisor 720 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 710. Services of hypervisor 720 may be provided by virtualizing in software or through hardware assisted resources that require minimal software intervention, or both. Multiple instances of a variety of guest operating systems may be managed by the hypervisor 720. Each platform 702 may have a separate instantiation of a hypervisor 720.

Hypervisor 720 may be a native or bare-metal hypervisor that runs directly on platform logic 710 to control the platform logic and manage the guest operating systems. Alternatively, hypervisor 720 may be a hosted hypervisor that runs on a host operating system and abstracts the guest operating systems from the host operating system. Hypervisor 720 may include a virtual switch 738 that may provide virtual switching and/or routing functions to virtual machines of guest systems 722. The virtual switch 738 may comprise a logical switching fabric that couples the vNICs of the virtual machines 732 to each other, thus creating a virtual network through which virtual machines may communicate with each other.

Virtual switch 738 may comprise a software element that is executed using components of platform logic 710. In various embodiments, hypervisor 720 may be in communication with any suitable entity (e.g., a SDN controller) which may cause hypervisor 720 to reconfigure the parameters of virtual switch 738 in response to changing conditions in platform 702 (e.g., the addition or deletion of virtual machines 732 or identification of optimizations that may be made to enhance performance of the platform).

Hypervisor 720 may also include resource allocation logic 744, which may include logic for determining allocation of platform resources based on the telemetry data (which may include stress information). Resource allocation logic 744 may also include logic for communicating with various components of platform logic 710 entities of platform 702A to implement such optimization, such as components of platform logic 710.

Any suitable logic may make one or more of these optimization decisions. For example, system management platform 706; resource allocation logic 744 of hypervisor 720 or other operating system; or other logic of computer platform 702A may be capable of making such decisions. In various embodiments, the system management platform 706 may receive telemetry data from and manage workload placement across multiple platforms 702. The system management platform 706 may communicate with hypervisors 720 (e.g., in an out-of-band manner) or other operating systems of the various platforms 702 to implement workload placements directed by the system management platform.

The elements of platform logic 710 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the computer platform 702A may be coupled together in any suitable manner such as through one or more networks 708. A network 708 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

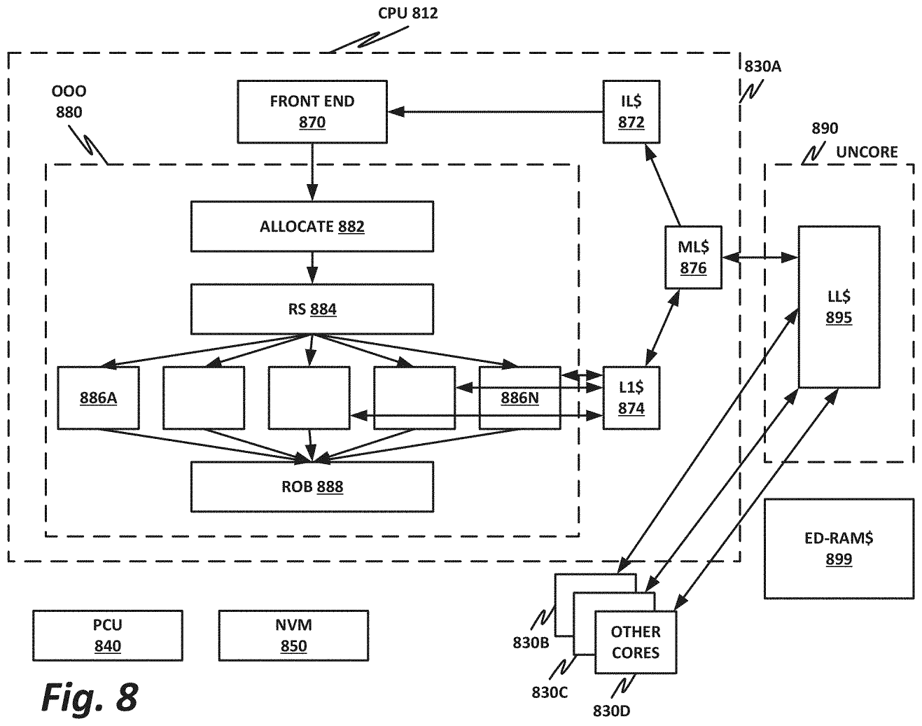

FIG. 8 illustrates a block diagram of a central processing unit (CPU) 812. Embodiments of CPU 812 may be configured or adapted to provide the method of providing persona-based contextual security as disclosed in the present specification.

Although CPU 812 depicts a particular configuration, the cores and other components of CPU 812 may be arranged in any suitable manner. CPU 812 may comprise any processor or processing device, such as a microprocessor, an embedded processor, a digital signal processor (DSP), a network processor, an application processor, a co-processor, a system-on-a-chip (SoC), or other device to execute code. CPU 812, in the depicted embodiment, includes four processing elements (cores 830 in the depicted embodiment), which may include asymmetric processing elements or symmetric processing elements. However, CPU 812 may include any number of processing elements that may be symmetric or asymmetric.

Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. A physical CPU may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

In the embodiment depicted, core 830A includes an out-of-order processor that has a front end unit 870 used to fetch incoming instructions, perform various processing (e.g., caching, decoding, branch predicting, etc.) and passing instructions/operations along to an out-of-order (OOO) engine. The OOO engine performs further processing on decoded instructions.

A front end 870 may include a decode module coupled to fetch logic to decode fetched elements. Fetch logic, in one embodiment, includes individual sequencers associated with thread slots of cores 830. Usually, a core 830 is associated with a first ISA, which defines/specifies instructions executable on core 830. Often, machine code instructions that are part of the first ISA include a portion of the instruction (referred to as an opcode), which references/specifies an instruction or operation to be performed. The decode module may include circuitry that recognizes these instructions from their opcodes and passes the decoded instructions on in the pipeline for processing as defined by the first ISA. Decoders of cores 830, in one embodiment, recognize the same ISA (or a subset thereof). Alternatively, in a heterogeneous core environment, a decoder of one or more cores (e.g., core 830B) may recognize a second ISA (either a subset of the first ISA or a distinct ISA).

In the embodiment depicted, the OOO engine includes an allocate unit 882 to receive decoded instructions, which may be in the form of one or more micro-instructions or uops, from front end unit 870, and allocate them to appropriate resources such as registers and so forth. Next, the instructions are provided to a reservation station 884, which reserves resources and schedules them for execution on one of a plurality of execution units 886A-886N. Various types of execution units may be present, including, for example, arithmetic logic units (ALUs), load and store units, vector processing units (VPUs), and floating point execution units, among others. Results from these different execution units are provided to a reorder buffer (ROB) 888, which take unordered results and return them to correct program order.

In the embodiment depicted, both front end unit 870 and OOO engine 880 are coupled to different levels of a memory hierarchy. Specifically shown is an instruction level cache 872, that in turn couples to a mid-level cache 876, that in turn couples to a last level cache 895. In one embodiment, last level cache 895 is implemented in an on-chip (sometimes referred to as uncore) unit 890. Uncore 890 may communicate with system memory 899, which, in the illustrated embodiment, is implemented via embedded DRAM (eDRAM). The various execution units 886 within OOO engine 880 are in communication with a first level cache 874 that also is in communication with mid-level cache 876. Additional cores 830B-830D may couple to last level cache 895 as well.

In particular embodiments, uncore 890 may be in a voltage domain and/or a frequency domain that is separate from voltage domains and/or frequency domains of the cores. That is, uncore 890 may be powered by a supply voltage that is different from the supply voltages used to power the cores and/or may operate at a frequency that is different from the operating frequencies of the cores.

CPU 812 may also include a power control unit (PCU) 840. In various embodiments, PCU 840 may control the supply voltages and the operating frequencies applied to each of the cores (on a per-core basis) and to the uncore. PCU 840 may also instruct a core or uncore to enter an idle state (where no voltage and clock are supplied) when not performing a workload.

In various embodiments, PCU 840 may detect one or more stress characteristics of a hardware resource, such as the cores and the uncore. A stress characteristic may comprise an indication of an amount of stress that is being placed on the hardware resource. As examples, a stress characteristic may be a voltage or frequency applied to the hardware resource; a power level, current level, or voltage level sensed at the hardware resource; a temperature sensed at the hardware resource; or other suitable measurement. In various embodiments, multiple measurements (e.g., at different locations) of a particular stress characteristic may be performed when sensing the stress characteristic at a particular instance of time. In various embodiments, PCU 840 may detect stress characteristics at any suitable interval.

In various embodiments, PCU 840 is a component that is discrete from the cores 830. In particular embodiments, PCU 840 runs at a clock frequency that is different from the clock frequencies used by cores 830. In some embodiments where the PCU is a microcontroller, PCU 840 executes instructions according to an ISA that is different from an ISA used by cores 830.

In various embodiments, CPU 812 may also include a nonvolatile memory 850 to store stress information (such as stress characteristics, incremental stress values, accumulated stress values, stress accumulation rates, or other stress information) associated with cores 830 or uncore 890, such that when power is lost, the stress information is maintained.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in an SoC, including CPU package. An SoC represents an integrated circuit (IC) that integrates components of a computer or other electronic system into a single chip. Thus, for example, client devices 110 or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

Note also that in certain embodiments, some of the components may be omitted or consolidated. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor, such as processor 610, can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, an FPGA, an erasable programmable read-only memory (EPROM), an electrically erasable programmable read-only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage such as storage 650 may store information in any suitable type of tangible, non-transitory storage medium (for example, RAM, ROM, FPGA, EPROM, electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, such as memory 620 and storage 650, should be construed as being encompassed within the broad terms ‘memory’ and ‘storage,’ as appropriate. A non-transitory storage medium herein is expressly intended to include any non-transitory, special-purpose or programmable hardware configured to provide the disclosed operations, or to cause a processor such as processor 610 to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application-specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated or sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

### Example Implementations

There is disclosed in one example, a computing apparatus, comprising: a hardware platform comprising a processor and a memory; a contextual reputation store; and instructions encoded within the memory to provision a security agent configured to: create a user persona in the contextual reputation store based at least in part on the user's interaction with the computing apparatus; compute a persona-weighted reputation for an action and store the persona-weighted reputation action to the contextual reputation store; intercept a user action on the computing apparatus; determine a current user persona; determine from the contextual reputation store a persona-weighted reputation for the user action; and take a security action based at least in part on the persona-weighted reputation for the user action.

There is further disclosed an example computing apparatus, wherein the security agent is further to enter or exit a user persona based at least in part on a persona trigger event.

There is further disclosed an example computing apparatus, wherein the persona trigger event comprises opening or closing an application.

There is further disclosed an example computing apparatus, wherein the persona trigger event comprises a change in mouse or keyboard focus.

There is further disclosed an example computing apparatus, wherein the persona trigger event comprises access to a website.

There is further disclosed an example computing apparatus, wherein the persona trigger event comprises accessing an e-mail address.

There is further disclosed an example computing apparatus, wherein the persona trigger event comprises a time of day.

There is further disclosed an example computing apparatus, wherein the user action is an administrative action.

There is further disclosed an example computing apparatus, wherein determining the persona-weighted reputation comprises comparing a speed of actions taken to a human-capable speed.

There is further disclosed an example computing apparatus, wherein determining the persona-weighted reputation comprises determining a strength of user authentication.

There is further disclosed an example computing apparatus, wherein the instructions are to provision the security agent at a privilege ring more privileged than user-space applications.

There is further disclosed an example computing apparatus, wherein the system agent includes a continuous system event monitor.

There is further disclosed an example computing apparatus, wherein the contextual reputation store includes a default persona for actions not falling within a persona otherwise defined.

There is further disclosed an example computing apparatus, wherein the security action is selected from the group consisting of allow, deny, and warn.

There is also disclosed an example of one or more tangible, non-transitory computer-readable mediums having stored thereon executable instructions to: profile a user's use of a computing apparatus; create a first user persona from the user of the computing apparatus, including a trigger for entering the first persona; define a first persona-specific score for a user action by a user operating within the first user persona; detect an instance of the user action while a user operates within the first persona; compute a reputation for the action from the persona-specific score; and take a security action according to the reputation.

There is further disclosed an example of one or more tangible, non-transitory computer-readable mediums, wherein the instructions are further to enter or exit a user persona based at least in part on a persona trigger event.

There is further disclosed an example of one or more tangible, non-transitory computer-readable mediums, wherein the persona trigger event is selected from the group consisting of opening an application, closing an application, a change in mouse or keyboard focus, accessing a website, accessing an e-mail address, and a time of day.

There is further disclosed an example of one or more tangible, non-transitory computer-readable mediums, wherein the persona trigger event comprises a change in mouse or keyboard focus.

There is further disclosed an example of one or more tangible, non-transitory computer-readable mediums, wherein the persona trigger event comprises access to a website.

There is further disclosed an example of one or more tangible, non-transitory computer-readable mediums, wherein the persona trigger event comprises accessing an e-mail address.

There is further disclosed an example of one or more tangible, non-transitory computer-readable mediums, wherein the persona trigger event comprises a time of day.

There is further disclosed an example of one or more tangible, non-transitory computer-readable mediums, wherein the user action is an administrative action.

There is further disclosed an example of one or more tangible, non-transitory computer-readable mediums, wherein computing the reputation for the action comprises comparing a speed of actions taken to a human-capable speed.

There is further disclosed an example of one or more tangible, non-transitory computer-readable mediums, wherein computing a reputation for the action comprises determining a strength of user authentication.

There is further disclosed an example of one or more tangible, non-transitory computer-readable mediums, wherein the instructions are further to provision a continuous system event monitor.

There is further disclosed an example of one or more tangible, non-transitory computer-readable mediums, wherein the instructions are further to define a second persona for the user, including a trigger for entering the second persona, and to assign a second persona-specific score to the action, the second persona-specific score different from the first persona-specific score.

There is also disclosed in an example a computer-implemented method of providing persona-based contextual security, comprising: generating a plurality of personas for a single user of a computing device based on the single user's varying patterns of usage in different computing contexts; defining a first persona-specific reputation for an action anticipated to be taken by the user in a first persona of the plurality of personas; entering a context of the first persona according to a first persona trigger; detecting an instance of the action within the first persona; determining a response to the action from the persona-specific reputation; and enacting the response.

There is further disclosed an example method, further comprising exiting the first persona based on a first persona exit event.

There is further disclosed an example method, wherein the first persona trigger is selected from the group consisting of opening an application, closing an application, a change in mouse or keyboard focus, accessing a website, accessing an e-mail address, and a time of day.

There is further disclosed an example method, wherein the first persona trigger comprises a change in mouse or keyboard focus.

There is further disclosed an example method, wherein the first persona trigger comprises access to a website.

There is further disclosed an example method, wherein the first persona trigger comprises accessing an e-mail address.

There is further disclosed an example method, wherein the first persona trigger comprises a time of day.

There is further disclosed an example method, wherein the action is an administrative action.

There is further disclosed an example method, wherein determining the response comprises comparing a speed of actions taken to a human-capable speed.

There is further disclosed an example method, wherein determining the response comprises determining a strength of user authentication.

There is further disclosed an example method, further comprising provisioning a continuous system event monitor.

There is further disclosed an example method, wherein the plurality of personas further comprises a second persona for the user, including a second persona trigger, and a second persona-specific reputation for the action different from the first persona-specific reputation for the action.

What is claimed is:

1. A computing apparatus, comprising:
a hardware platform comprising a processor and a memory;
a contextual reputation store; and
instructions encoded within the memory to provision a security agent configured to:
create a user persona in the contextual reputation store based at least in part on the user's interaction with the computing apparatus;
compute a persona-weighted reputation for an action and store the persona-weighted reputation action to the contextual reputation store;
intercept a user action on the computing apparatus;
determine a current user persona;
determine from the contextual reputation store a persona-weighted reputation for the user action; and
take a security action based at least in part on the persona-weighted reputation for the user action.

2. The computing apparatus of claim 1, wherein the security agent is further to enter or exit a user persona based at least in part on a persona trigger event.

3. The computing apparatus of claim 2, wherein the persona trigger event comprises opening or closing an application.

4. The computing apparatus of claim 2, wherein the persona trigger event comprises a change in mouse or keyboard focus.

5. The computing apparatus of claim 2, wherein the persona trigger event comprises access to a website.

6. The computing apparatus of claim 2, wherein the persona trigger event comprises accessing an e-mail address.

7. The computing apparatus of claim 2, wherein the persona trigger event comprises a time of day.

8. The computing apparatus of claim 1, wherein the user action is an administrative action.

9. The computing apparatus of claim 1, wherein determining the persona-weighted reputation comprises comparing a speed of actions taken to a human-capable speed.

10. The computing apparatus of claim 1, wherein determining the persona-weighted reputation comprises determining a strength of user authentication.

11. The computing apparatus of claim 1, wherein the instructions are to provision the security agent at a privilege ring more privileged than user-space applications.

12. The computing apparatus of claim 1, wherein the system agent includes a continuous system event monitor.

13. The computing apparatus of claim 1, wherein the contextual reputation store includes a default persona for actions not falling within a persona otherwise defined.

14. The computing apparatus of claim 1, wherein the security action is selected from the group consisting of allow, deny, and warn.

15. One or more tangible, non-transitory computer-readable mediums having stored thereon executable instructions to:
profile a user's use of a computing apparatus;
create a first user persona from the user of the computing apparatus, including a trigger for entering the first persona;
define a first persona-specific score for a user action by a user operating within the first user persona;
detect an instance of the user action while a user operates within the first persona;
compute a reputation for the action from the persona-specific score; and
take a security action according to the reputation.

16. The one or more tangible, non-transitory computer-readable mediums of claim 15, wherein the instructions are further to enter or exit a user persona based at least in part on a persona trigger event.

17. The one or more tangible, non-transitory computer-readable mediums of claim 16, wherein the persona trigger event is selected from the group consisting of opening an application, closing an application, a change in mouse or keyboard focus, accessing a website, accessing an e-mail address, and a time of day.

18. The one or more tangible, non-transitory computer-readable mediums of claim 15, wherein the instructions are further to define a second persona for the user, including a trigger for entering the second persona, and to assign a second persona-specific score to the action, the second persona-specific score different from the first persona-specific score.

19. A computer-implemented method of providing persona-based contextual security, comprising:
generating a plurality of personas for a single user of a computing device based on the single user's varying patterns of usage in different computing contexts;
defining a first persona-specific reputation for an action anticipated to be taken by the user in a first persona of the plurality of personas;
entering a context of the first persona according to a first persona trigger;
detecting an instance of the action within the first persona;
determining a response to the action from the persona-specific reputation; and
enacting the response.

20. The method of claim 19, wherein the plurality of personas further comprises a second persona for the user, including a second persona trigger, and a second persona-specific reputation for the action different from the first persona-specific reputation for the action.
